(19) United States
(12) Patent Application Publication
(10) Pub. No.: US 2004/0105959 A1
(43) Pub. Date: Jun. 3, 2004

(54) Edge sharpener

(75) Inventors: Thomas J. Pearsall, Palm City, FL (US); Stephen C. Martin, Tequesta, FL (US)

Correspondence Address: William L. Krayer, 1771 Helen Drive, Pittsburgh, PA, 15216, US

(73) Assignee: Ceramic Coatings Technologies, Inc.

(21) Appl. No.: 09/939,449

(22) Filed: Aug. 25, 2001

(51) Int. Cl. B32B 1/00; B32B 3/00; D06N 7/04; B24B 1/00; B24D 11/00; B24B 5/00; B24B 7/00; B23F 21/03; B23F 21/23; B24B 33/00; C25D 5/18; C25D 11/00

(52) U.S. Cl. 428/143; 428/148; 428/149; 428/156; 51/295; 451/540; 205/107

(57) ABSTRACT

An edge sharpening device has a metal body and at least one honing surface coated with ceramic created in an electrolytic bath. Profiles of the device can be triangular, planar, or V-shaped as well as curved. The ceramic can be deposited by passing a modified shaped wave alternating current through the incipient sharpening device in the presence of a passivating agent and an electrolytic agent.

### TECHNICAL FIELD

A metal surface contoured for edge sharpening is treated in an electrolytic bath by a method particularly effective for making a ceramic sharpening and/or honing surface on the edge sharpening contour.

### BACKGROUND OF THE INVENTION

Over the years and indeed throughout human history, edge sharpening devices have taken many different forms and have been made from many different materials. In contemporary times, one of the more popular materials is alumina ceramic that has been fabricated by compaction of powdered material and fired at high temperatures to produce a hard, dense solid product. Other methods of manufacture include high-pressure compaction of ceramic slurries or powders with binder materials added. In all such cases the final product is subjected to high temperatures and, in some cases, pressures, to produce a very hard, dense shape that will sharpen or hone a cutting edge. However, ceramics so produced are somewhat brittle and susceptible to damage in the form of chipping or breakage when dropped or impacted by hard objects.

Regardless of the geometric shape of the sharpening or honing device, it is the material from which it is manufactured that is the determining factor in its effectiveness at creating and maintaining a sharp cutting edge. Ceramic is the material of choice to produce extremely sharp edges. But solid or monolithic ceramic materials, having some glass-like properties, are prone to chip or break.

Solid ceramic materials, even as relatively coarse embedded grain, are not best suited for the removal of more than minimal amounts of material from a cutting edge. Harsh abrasives like silicon carbide or super-abrasives like diamond are better suited to remove greater quantities of basis or edge support material—that is, metal or other material not proximate to the cutting edge—to, for instance, repair and regenerate a cutting edge that has been damaged by misuse or has become severely dulled. Once the cutting edge profile has been restored by use of the more abrasive materials, a ceramic device may be used to produce and maintain a fine, razor sharp edge.

There remains a need for a sharpening device having ceramic surfaces that will not chip or break. Further, it would be desirable to combine in a single sharpening device the ability of the known abrasives to remove larger amounts of material with the finer honing abilities of ceramic.

### SUMMARY OF THE INVENTION

The present invention provides a strong metallic substrate, not susceptible to chipping or breakage, the surface of which has been converted to a ceramic applied electrolytically in a particular manner. The process we prefer for creating a hard ceramic surface is described by Samsonov and Hitterer in U.S. Pat. No. 5,616,229. They propose the formation of ceramic coatings of up to 300 microns thick within about 90 minutes through the use of an alternating current of at least 250 volts having a shaped wave (not the conventional sinusoidal form) which rises from zero to its maximum height and falls to below 40% of its maximum height within less than a quarter of its full alternating cycle, thereby causing dielectric breakdown, the alternating current being imposed on an electrolytic bath in which the metal subject to be treated is an electrode, the bath comprising initially an alkali metal hydroxide and in a later step including an oxyacid salt of an alkali metal, such as sodium tetrasilicate. While the '229 patent speaks of forming coatings on aluminum surfaces, the authors do not treat the possible use of such a coating process for application to the unique contours of aluminum or other shapes designed for sharpening devices. The entire specification of the Samsonov and Hitterer U.S. Pat. No. 5,616,229 is incorporated herein by reference, as we use its teachings in the creation of ceramic coatings on our sharpening devices. It should be observed that the ceramic coating is not merely laid down on the metal surface, but the surface of the metal is actually transformed by the drastic action of the current acting on it, i.e. the dielectric breakdown in the presence of the electrolytic bath ingredients. Aluminum is preferred as the substrate metal, but other metals may be used, particularly titanium, magnesium, beryllium and alloys thereof.

We use a modified shaped-wave electrolytic process to form a hard coating on the incipient sharpening device. The process may use the teachings of U.S. Pat. No. 5,616,229 and accordingly that patent is hereby incorporated by reference, in its entirety, into this disclosure. However, the '229 patent uses two distinct electrolytic baths for the substrates discussed, and we have found it is not necessary to do so for sharpener stock, particularly of aluminum. The ceramic layer is formed by conversion of the aluminum or other metal surface to a hard, wear resistant ceramic by a microarc oxidation process employing an electrolyte and controlled high voltage alternating current to create a plasma discharge at the interface between the aluminum or other metal element and the electrolyte.

Our method includes forming a hard coating on the incipient sharpening device by immersing it first in an electrolytic bath comprising (deionized) water, an alkali metal salt or hydroxide (preferably potassium hydroxide) as an electrolytic agent, at a concentration of 0.5-7 grams per liter (preferably 0.5-3 grams per liter), and, as a passivating agent, a colloidal suspension of sodium silicate in the form Na₂O.xSiO₂ (x=>2.55 by weight) at a concentration of 2-15 grams per liter while conducting through the bath a modified shaped-wave alternating electric current from a source of at least 250-800 volts through the surface of the incipient sharpening device. The modified shaped-wave electric current rises from zero to its maximum height and falls to below 40% of its maximum height (amplitude) within less than a quarter of a full alternating cycle, thereby causing dielectric breakdown and the formation of a dense, hard ceramic film on the incipient sharpening device surface.

Thus our invention includes making a sharpening device comprising forming a hard coating on an incipient sharpening device by (i) immersing the incipient sharpening device in an electrolytic bath comprising a passivating agent and an electrolytic agent, and (ii) passing a modified shaped-wave alternating electric current from a source of 250 to 800 volts through the surface of the incipient sharpening device, wherein the modified shaped-wave electric current rises from zero to its maximum height and falls to below 40% of its maximum height within less than a quarter of a full alternating cycle thereby causing dielectric breakdown and the formation of a ceramic coating on the sharpener surface, and removing the completed sharpening device from the electrolytic bath. Preferably, the electrode will be positioned so that it is peripherally substantially equidistant from the incipient sharpener; generally this is best accomplished with a specially designed conforming electrode.

### BRIEF DESCRIPTION OF THE DRAWINGS

FIGS. 1a and 1b illustrate honing devices of our invention, having a groove for sharpening points and different types of edges.

FIGS. 2a and 2b show an elongated triangular sharpening device covered with ceramic applied in accordance with our invention; one of the sides in FIG. 2b includes an abrasive surface.

FIG. 3 shows a set of tapered honing devices of our invention.

In FIG. 4, the metal bar has wide radius curves, and a recess is shown without the abrasive strip.

FIG. 5 shows a bench mount sharpener utilizing sharpening wheels of our invention.

In FIG. 6a, we show a conforming electrode of our invention, for use in assuring adequate ceramic coating on all surfaces of an elongated triangular sharpener. FIG. 6b is an enlarged view of the holes in the conforming electrode. The disposition of the incipient sharpener is shown in the electrolytic bath in FIG. 6c.

### DETAILED DESCRIPTION OF THE INVENTION

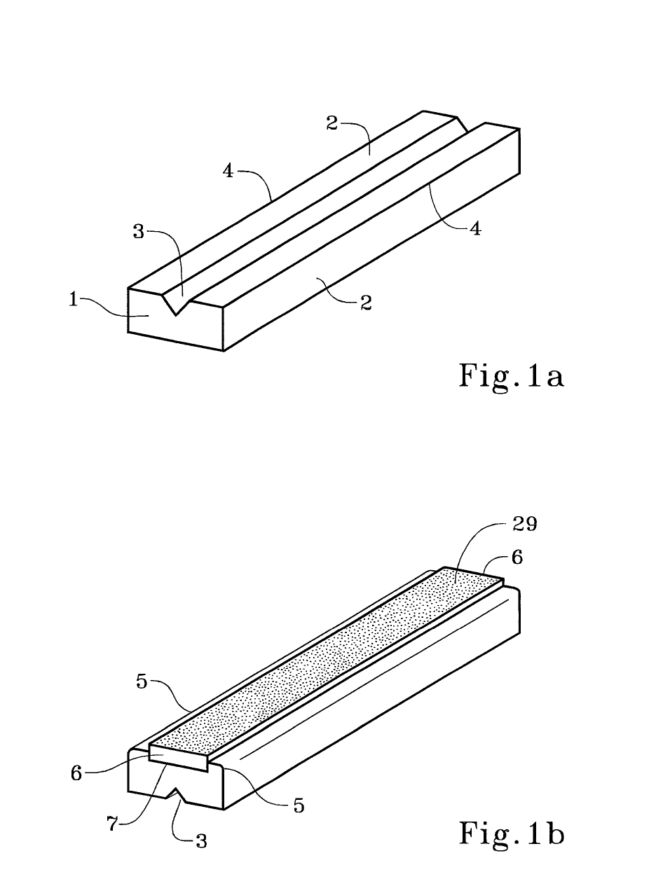

Referring now to FIG. 1a, a honing device is made from solid metal, preferably aluminum. It may be cast, extruded or fabricated from metal stock such as bar stock. The metal body 1 is covered by a ceramic layer 2 from 0.001 inch (25μ) to 0.012 inch (300μ) thick. The ceramic covering extends into V-groove 3 designed for sharpening points such as fish hooks. V-groove 3 is preferably about 60 degrees at its apex, but may vary from 30 to 75 degrees. The device of FIG. 1a has corner edges 4 of about 90 degrees. The sharpening device is preferably designed to be hand-held or mounted in a suitable base, and therefore is generally from about 2 to about 12 inches long and ½ inch to four inches wide. Our ceramic creating process assures that the ceramic coating on edges 4, as well as the other surfaces, will be durable and serviceable for long periods.

FIG. 1b shows a device of our invention similar to that of FIG. 1a except that the edges 5 are rounded and an abrasive strip 6 is shown to be affixed into recess 7. Recess 7 and abrasive strip 6 may be of any convenient length and width. Recess 7 is part of the basic metal body, and accordingly may be covered with a ceramic layer during the electrolytic ceramic forming process described. The abrasive strip may be any hard particulate or granular grinding material adhered to a base strip, such as grits 29 of silicon carbide, aluminum oxide, or diamond. The strip we prefer is a self-adherent flexible strip having the abrasive particulate matter adhered to it. It is not necessary to include a recess 7 for the strip 6—that is, strip 6 may be affixed directly onto a surface of the metal body, whether or not it is already covered with a ceramic layer. We prefer, however, that the abrasive strip be cemented or otherwise adhered to a surface already covered by ceramic, as our ceramic coating provides a surface more compatible with most cements and adhesives than the bare metal. Flexible adhesive abrasive strip may be applied to gently curved surfaces as well as substantially flat ones. A V-groove 3 is similar to that of FIG. 1a.

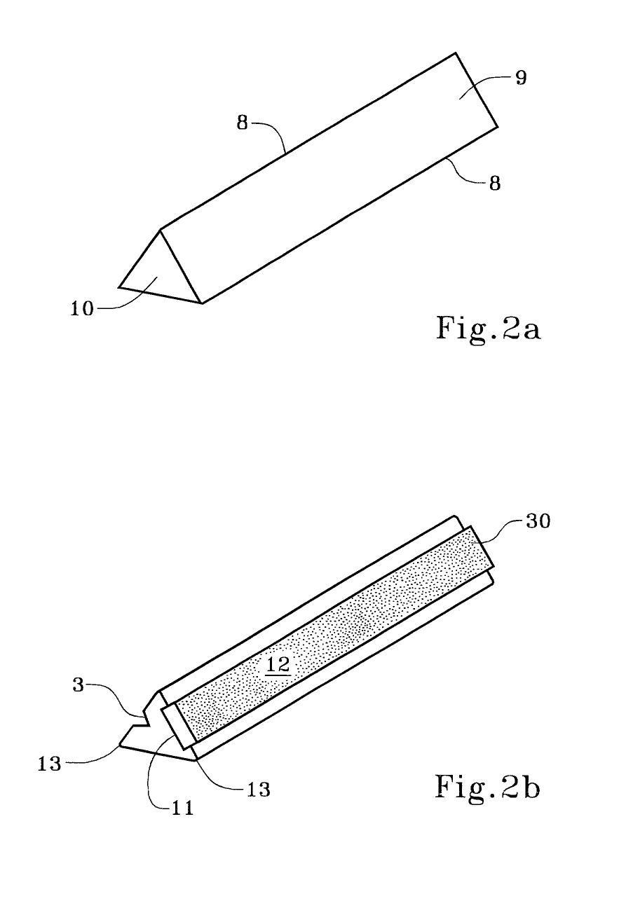

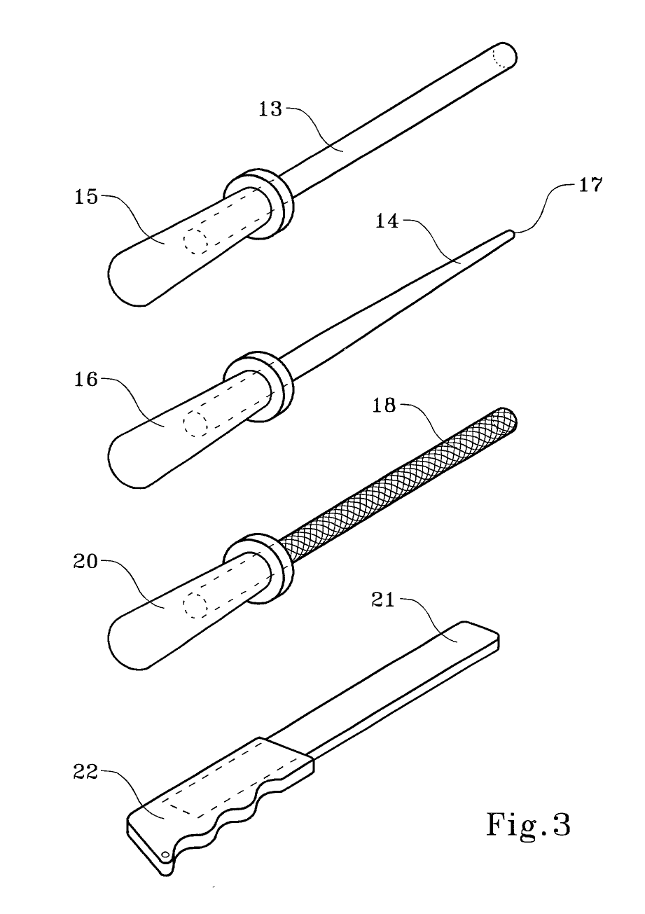

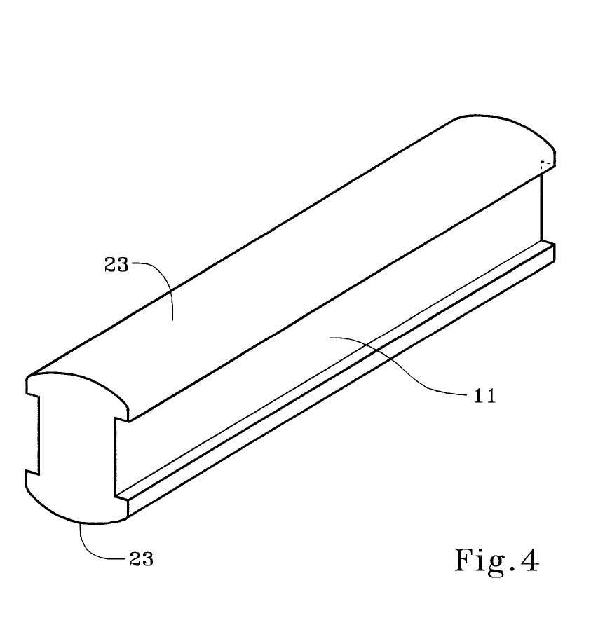

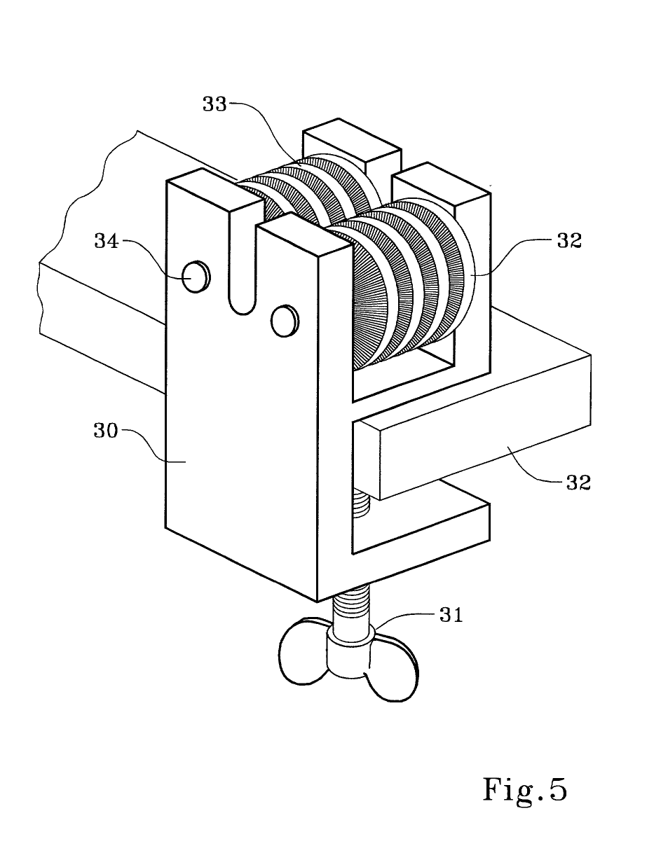

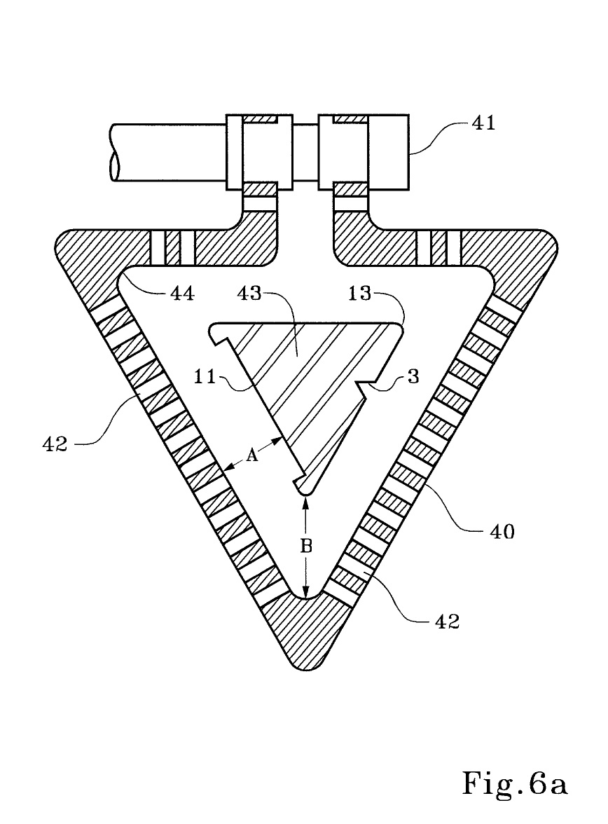

FIG. 2a is an elongated triangular shaped sharpening device having 60° corner edges 8; the device is covered with our ceramic coating 9, and preferably also on ends 10. In FIG. 2b, one side of the device includes a recess 11 for an abrasive strip 12, and the edges 13 are rounded to a small radius. A V-groove 3 may also be used. The depicted equilateral triangular shape profile is not essential—any desired or convenient combination of angles may be used for the triangular sectional shape. Other metal bar stock may be used in the electrolytic ceramic coating process—that is, a hexagonal or octagonal profile may be desired to provide both flat surfaces and edge angles wider than the triangular bar stock would normally provide. Likewise any desired shape, length, and width may be used for the abrasive strip 12.

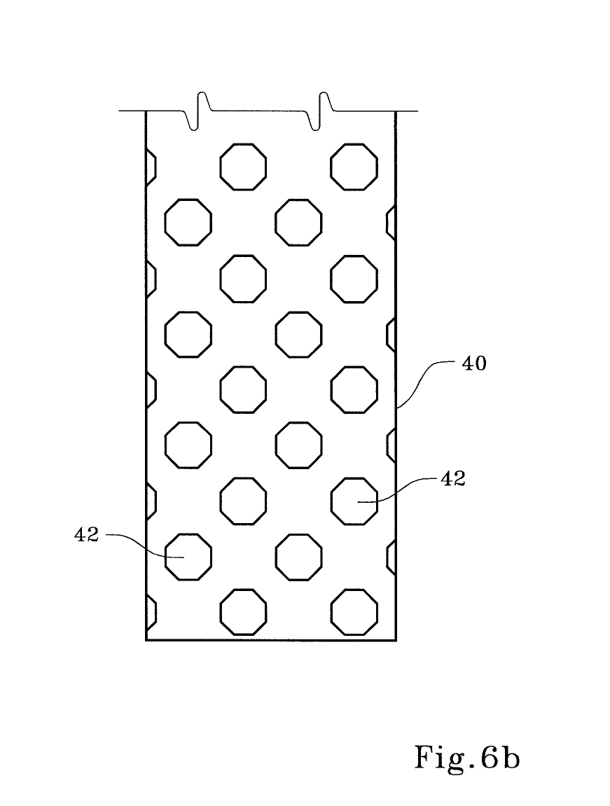

FIG. 3 shows a family of honing sticks and paddles for which our invention is especially advantageous. The honing sticks 13 and 14 are seen to be mounted on handles 15 and 16. Honing stick 13 is of a substantially cylindrical shape. Generally it will be desirable to make the honing stick 13 from 2 to 14 inches long and the diameter from 1/8 inch to 2 inches. The metal body on which the coating is fixed can be solid or tubular. Honing stick 14 is tapered. The degree of tapering will depend to some extent on the length of the honing stick; the honing stick may end in a point, but we prefer to use a blunt end 17. The entire honing stick 14 is covered with the ceramic coating applied by the process described above. Honing stick 18 is knurled, as may be seen by the knurling pattern 19 and also has a handle 20. The ceramic application process described above is well adapted to create a ceramic coating on the knurled surface of the underlying metal body which, again, may be tubular or solid metal, but we prefer solid metal for the knurled honing stick. Paddle 21 is of a generally flat shape and size which can be conveniently fixed to handle 22.

FIG. 4 shows a curved surface 23 of wide radius, and a recess 11 before an abrasive strip is fixed to it.

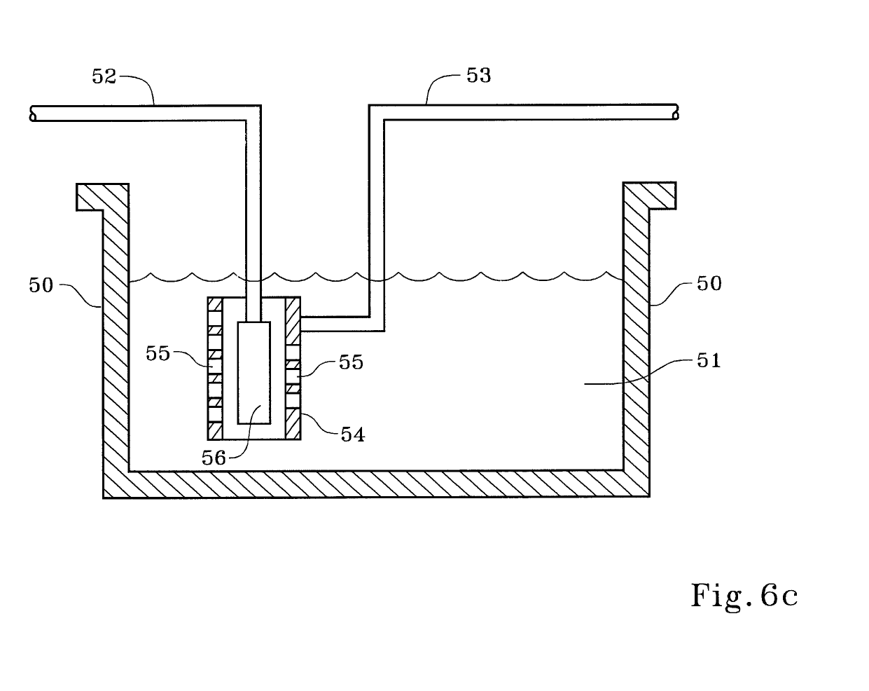

FIG. 5 shows a bench mount sharpener utilizing sharpening wheels of our invention.

Clamp 31 secures the housing 30 to bench segment 32. Shafts 34 pass through housing 30 and support sharpening wheels 32 and 33. A double series of wheels 32 and 33 is preferred as shown. The wheels 32 and 33 are coated with ceramic as described elsewhere herein and the sharpener is made in an otherwise conventional manner.

In FIGS. 6a, 6b, and 6c, we illustrate how a special electrode 40 (FIG. 6a) or 54 (FIG. 6c) is disposed around the incipient sharpener 43 or 56 in the electrolytic cell 50. Referring first to FIG. 6a, our conforming electrode 40 is seen to be substantially concentric with the incipient elongated triangular sharpener 43. Encipient sharpener 43 is substantially similar to the sharpener of FIG. 2a, having both a V-groove 3 and a recess 11 for an abrasive strip. Internal corners 44 of the conforming electrode 11 may be designed to be a distance B from corners 13 of the triangular profile of the sharpener 13; B is preferably rounded as shown, but the internal surface of conforming electrode 40 is not a constant distance at any point within the enclosed area. Edges 13 of the sharpener will receive the greatest value of current, but it will not be as much as it would have been if distance B had been made shorter. Likewise, distance A is seen to be greater than around the remainder of the periphery of the sharpener, and accordingly the bottom surface of recess 11 will create less ceramic than the other surfaces of the sharpener, but it should be remembered that the recess 11 is intended to be covered with an abrasive strip and will not be needed for honing. The electrode 40 has holes in it to assure a free flow of electrolyte into and out of the area occupied by the sharpener. Electrode 40 is connected to the power source through connection 41, equivalent to cable 53 in FIG. 6c.

In FIG. 6c, cell 50 contains an electrolytic bath of the type described. In it is suspended an incipient sharpener 56, connected to the power circuit by cable 52. Also suspended is a conforming electrode 54 having holes 55 similar to holes 42 in FIG. 6a. An even coating of ceramic is assured on the sharpener 56, because of the conforming geometry of electrode 54. FIG. 6b is an expanded view of a part of a conforming electrode 40, showing holes 42. Holes 42 need not be evenly spaced as shown, but may be spaced randomly or, in some cases, designed to assure higher flow rates of bath solution to particular areas of the sharpener.

The bath 51 in cell 50 is an electrolyte solution comprising deionized water, 2 to 60 or more grams per liter, preferably 2 to 15 grams per liter, of a passivating agent and from 0.5 to 7, preferably 0.5-3, grams per liter of an electrolytic agent. The passivating agent is preferably sodium tetrasilicate, as described above, but may be an alkali metal polyphosphate, chromate, molybdate, vanadate, tungstate, aluminate, or any other silicate. Any strong salt, acid, or base capable of forming an oxide with the metal substrate of the incipient sharpener, such as H₂SO₄, KOH, NaOH, NaF, Na₂SO₄, H₃PO₄ and NaPO₃ may be used as the electrolytic agent, but we prefer potassium hydroxide.

Definitions

Abrading: This refers to removing larger amounts of material relative to honing. Generally it involves a grit of high hardness such as diamond, silicon carbide, or aluminum oxide; the grit may be of a size 60μ to 400μ.

Honing: This refers to removing smaller amounts of material relative to abrading. Our ceramic surface is excellent for honing—it exhibits a surface finish of Ra 120 to Ra 10 and removes substantially less material than abrasion, resulting in a smooth sharp edge.

Edge: As applied to our sharpeners, the convergence of two substantially flat planar surfaces at an angle less than 150°. The edge may be rounded, preferably by a radius up to 0.2 inch, or may be sharp.

1. An article useful for edge sharpening comprising a metal body having at least one honing surface coated with a ceramic created in an electrolytic bath.

2. An article of claim 1 having a handle.

3. An article of claim 1 wherein said metal body is aluminum.

4. An article of claim 1 wherein said abrading surface comprises a grit selected from aluminum oxide, silicon carbide, and diamond.

5. An article of claim 1 wherein at least one honing surface is substantially flat.

6. An article of claim 1 wherein at least one honing surface is curved.

7. An article of claim 1 having a V groove therein.

8. An article of claim 1 having at least one edge treated in said electrolytic bath to concentrate current thereon while said ceramic coating is created on said surface.

9. An article of claim 1 including at least one abrading surface.

10. An article of claim 9 wherein said abrading surface is an abrasive strip affixed to a recess in said article.

11. An article of claim 10 wherein said abrading surface comprises silicon carbide, diamond or aluminum oxide.

12. An article of claim 1 having a triangular profile.

13. An article of claim 7 having a triangular profile.

14. An article of claim 12 having at least one V groove.

15. An article of claim 12 having at least one abrading surface.

16. An article of claim 15 wherein said abrading area is affixed to a recess in the surface of said article.

17. An article of claim 15 wherein said abrading area comprises silicon carbide, diamond, or aluminum oxide.

18. An elongated sharpening bar comprising a generally rectangular-shaped metal body having attached thereto at least one abrasive strip, the balance of said bar being substantially covered with a ceramic coating created in an electrolytic bath.

19. Article of claim 8 wherein said edge is rounded.

20. Method of making a sharpening device having at least one edge comprising placing a metal incipient sharpening device as an electrode in an electrolytic bath and imposing a modified shaped wave alternating current in said bath.

21. Method of claim 20 wherein said modified shaped wave alternating current creates a plasma discharge within said bath, resulting in microarc oxidation on the surface of said incipient sharpening device.

22. Method of making a sharpening device comprising forming a hard coating on an incipient sharpening device by (i) immersing the incipient sharpening device in an electrolytic bath comprising a passivating agent and an electrolytic agent, and (ii) passing a modified shaped-wave alternating electric current from a source of 250 to 800 volts through the surface of the incipient sharpening device, wherein the modified shaped-wave electric current rises from zero to its maximum height and falls to below 40% of its maximum height within less than a quarter of a full alternating cycle thereby causing dielectric breakdown and the formation of a ceramic coating on the surface of said incipient sharpening device, and removing the completed sharpening device from the electrolytic bath.

23. An edge sharpening device comprising an elongated metal body having a ceramic surface on at least two contour portions selected from flat, rounded edge, and tapered.

24. An edge sharpening device of claim 23 wherein said metal body is aluminum.

25. An edge sharpening device including at least one of a V groove and an abrasive strip.
